(19) United States
(12) Patent Application Publication
(10) Pub. No.: US 2002/0087646 A1
(43) Pub. Date: Jul. 4, 2002

(54) System and method for group electronic mailbox

(76) Inventors: Matthew W. Hickey, Portland, OR (US); James H. Wolfston, West Linn, OR (US)

Correspondence Address: MICHAEL O. SCHEINBERG, P.O. BOX 164140, AUSTIN, TX, 78716-4140, US

(21) Appl. No.: 09/999,062

(22) Filed: Oct. 31, 2001

Related U.S. Application Data
(60) Provisional application No. 60/245,777, filed on Nov. 1, 2000.

(51) Int. Cl. G06F 15/16

(52) U.S. Cl. 709/206

(57) ABSTRACT

A group electronic mail (e-mail) mailbox is provided to enable multiple users to work collaboratively and simultaneously with one or more electronic communications received in the group e-mail mailbox. The group e-mail mailbox provides tools that allow members of a group to access and manipulate the received electronic communications. Status information associated with the received electronic communications is provided to active members of the group. To allow the active members of the group to simultaneously monitor the status of the received electronic communications, the status information being presented to the active members of the group can be selectively updated. Predefined responses in response to such electronic communications may be prepared and/or sent automatically. The contents of the predefined responses are determined from the received electronic communication or may be determined according to the contents of a filter specifying a criterion or criteria. Alternatively, one or more members can reply in response to the received electronic communication. Any users including the sender can be selectively notified either automatically when a received electronic communication meets a prespecified criteria defined in the filter or by any member of the group.

This application claims priority from U.S. Provisional Patent Application No. 60/245,777 filed Nov. 1, 2000 and hereby incorporated by reference.

### TECHNICAL FIELD OF THE INVENTION

The present invention relates to the field of electronic mail systems, and more particularly, to a system and method for managing distribution and storage of electronic communications, such as electronic mails, within an electronic mailbox.

### BACKGROUND AND SUMMARY OF THE INVENTION

Businesses, educational institutions, individuals, and governments use electronic mail (e-mail) systems for everything from personal to professional communication. Indeed, electronic mail is developing into a preferred alternative to the telephone, conventional paper mail service, and facsimile transmission. In electronic mail systems, a user can perform a number of activities such receiving, sending, composing, forwarding, storing, and retrieving text, graphics, images and voice data. Such activities are typically performed by users having individual electronic mailboxes.

Enterprises, such as business and non-profit institutions are generally divided up into groups of people that work together to perform related functions. Examples of such groups include members of a technical support staff or members of a college administrative department (e.g., admissions, alumni, financial aid). Each member of a group typically has an individual electronic mailbox to receive electronic communications. One of the conveniences that e-mail systems provide is the ability to almost instantaneously distribute electronic communications via computer or communication networks not just to individuals but to a group of recipients simply by identifying multiple destination addresses. The distribution of an electronic communication to the individual mailboxes of members within the group may be done automatically by the e-mail system, for example, whenever the communication is addressed to a particular group address or manually, for example, by an individual in the group forwarding copies to others in the group. After the e-mail is distributed, it is generally kept in the inboxes of the individual users.

The copies of the e-mail message in each member's box exist independently and are not linked. Electronic mailboxes are configured for use by only one user at a time. Thus, it is difficult for members of the group to coordinate their actions. For example, it can be difficult to establish whether any member of the group has responded to a particular received electronic communication without individually contacting each member of the group. It can also be difficult to obtain other status information such as how, when, and by whom in the group the communication is being processed. Information that should be made available in a timely manner to each group member may not be shared at all or at least not simultaneously.

FIG. 1 depicts a functional block diagram of a prior art e-mail system 10. E-mail system 10 comprises e-mail mailboxes 20₁-20ₙ created for respective users U₁-Uₙ to communicate with each other by exchanging e-mail messages 21 over a computer or communication network 15. Each user is assigned a unique e-mail address with an associated e-mail mailbox for receiving and storing e-mail messages 21.

E-mail system 10 allows users to be combined into distribution groups. For example, a group 22 consists of users U₁, U₂, and U₃ each having an associated and respective e-mail mailbox 20₁, 20₂ and 20₃. An e-mail 21 addressed to group 22 is received in the respective e-mail mailbox 20₁, 20₂ and 20₃ for the users U₁, U₂, and U₃. In e-mail system 10, e-mail mailboxes 20₁-20₃ are configured for use by only one user at a time. It can also be difficult for a member of group 22 to determine whether an e-mail received from outside the group and distributed to group 22 is appropriately handled or not by other group members, thereby making it almost difficult to work collaboratively and/or simultaneously. It can be even more difficult for any of the users U₁, U₂, and U₃ in group 22 to acquire or track the status of the received e-mail to determine any actions taken by any of the members of the group 22. Further, if an e-mail is distributed or forwarded to just a single member or a subset of members of group 22, the same e-mail will not be available to the other remaining members of the group 22 unless it is also distributed or forwarded individually to the other members of group 22. Therefore, some group members may be deprived of information regarding the received e-mail message and the actions taken by the other group members in connection with the message. In addition, there is limited control on the flow, distribution and processing of the information intended to be shared among the members of group 22.

Consequently, it can be difficult for different members of a group to work collaboratively without frequent telephonic or electronic communications across the whole group. Moreover, the lack of simultaneous sharing of all the electronic communications intended for use by the whole group can severely impair an efficient and coordinated functioning of a group.

Accordingly, it is an object of the invention to provide a group electronic mailbox for multiple members or users of a group to work collaboratively with received electronic communications.

It is another aspect of the invention to provide a group electronic mailbox that is simultaneously accessible to multiple members or users of the group electronic mailbox.

It is a further aspect of the invention to provide tools that allow members or users of a group to selectively operate on such electronic communications.

It is yet another aspect of the invention to provide a feature to prepare predefined responses which may be sent automatically in response to the electronic communications addressed to a group and received in a group electronic mailbox.

It is still another aspect of the invention to provide a feature in an electronic mail system to include user defined alternate delivery instructions other than the default delivery instructions for received electronic communications.

It is yet another aspect of the invention to identify and display to members or users of a group an associated item status and a set of item attributes for each received electronic communication resident in a group electronic mailbox.

It is still a further aspect of the invention to provide an automatic method for updating and notifying members or users of a group of any changes in status information of received electronic communications, the received electronic communications are being continually operated on by multiple members or users of the group to cause changes in their statuses.

In the present invention, a system and method is provided for multiple users to concurrently share one or more electronic communications. The electronic communications reside in electronic mailbox that is accessible by members of the group. When an authorized member of the group takes an action with regard to the electronic communication, other members of the group can see what has been done. Thus, the members of the group can coordinate their activities with respect to the electronic communication.

In one embodiment, an electronic mail system includes a mail server, a mail parser, a database, a set of tools and a client user interface to communicate with the mail server. One or more group electronic mailboxes are configured at the mail server to serve a plurality of users within an institution. Each group electronic mailbox is uniquely identified by an institution identification number. Each group electronic mailbox can be accessed by a selected set of users from the plurality of users within the institution. Each group electronic mailbox comprises an inbox for storing inbound electronic communications addressed to the institution identification number. A set of tools is provided to the users for creating and for applying instructions to be performed on selected electronic communications.

The database contains an ordered pair comprising a user login identification and a password for each of the users within the institution. Each ordered pair is assigned a permission attribute that defines access rights for one or more group electronic mailboxes of the institution. For example, a first permission attribute maps each ordered pair associated with the members of a group to a group electronic mailbox and defines the group's access rights. The members of the first group are provided access to view and selectively to manipulate the electronic communications within the group electronic mailbox. Any member of the group can define one or more alternate delivery instructions for the inbound electronic communications. For example, the members of the first group can use a criteria template generation interface filter to specify a criteria template and then associate with the criteria template instructions for an automated response or for directing the received electronic communication to a selected mailbox other than the default inbox of the first group electronic mailbox.

In operation, when an inbound electronic communication is received in the electronic mail system the mail parser parses the inbound electronic communication. The mail parser employs pre-defined criteria templates to determine whether to deliver the electronic communication to its addressee or to apply one or more user-defined alternate delivery instructions. The received electronic communication addressed to the group is typically delivered to the group's electronic mailbox for storage unless determined otherwise according to the alternate delivery instructions.

Once the electronic communication is stored in the group electronic mailbox, any member of the group can view the stored electronic communication and any member of the group having an appropriate permission attribute can determine an appropriate response or an action responsive to the electronic communication. For example, an individual member of the group can select actions from a set of response tools for performing desired functions.

A member of the group requesting access to the group electronic mailbox provides an ordered pair of the user login identification and the password via the client user interface to the mail server. The mail server compares the ordered pair of the requesting member with the institution identification numbers and retrieves from the database a stored first electronic communication corresponding to the ordered pair. The retrieved electronic communication is placed in the inbox of the group electronic mailbox and displayed through a client user interface. The group electronic mailbox includes in the user interface a status indicator for each of the received electronic mails. A change in status of a received electronic mail in response to one or more prior acts of a first group member performed on the received electronic mail is communicated to other group members when they view the status of the electronic mail. A set of tools is provided with the group electronic mailbox view to allow members of the group to selectively operate on the displayed electronic communication. The view of the group electronic mailbox includes for each received electronic communication in the mailbox a profile including an associated status and one or more attributes derived from the received first electronic communication.

In one embodiment, when an electronic mail is transferred to an inbox of a group electronic mailbox, several options for responding to the received electronic mail are available to group members. In accordance with one option, one or more predefined responses may be generated automatically by the electronic mail system as described in more detail in a U.S. patent application to Hickey et al. for “Automatic Data Transmission in Response to Content of Electronic Forms Satisfying Criteria,” assigned to the assignee of the present application and filed Nov. 1, 2000 concurrently herewith. A template is provided to members of the group for specifying the format and content of one or more predefined responses. A group member specifies match criteria that define the predefined response to be automatically generated. When the information in a received electronic mail meets the specified response criteria, the predefined response is automatically initiated. Alternatively, a member of the group may predefine a response to a received electronic mail. For example, the predefined response may electronically notify a person, who may or may not be the sender of the electronic mail.

In accordance with another option, a group member defines distribution criteria and electronic mail is stored in a specific storage location determined from the defined distribution criteria.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and the advantages thereof, reference is now made to the following descriptions taken in conjunction with the accompanying drawings, in which:

FIG. 1 is a functional block diagram of a prior art electronic mail system.

FIG. 2 is a high-level functional block diagram of an electronic mail system embodying the present invention.

FIG. 3 is a block diagram of one embodiment of an electronic mail system in accordance with the present invention

FIG. 4 is a flow chart showing the steps of one embodiment of the present invention.

FIG. 5 is a block diagram showing additional detail of some of the components shown in FIG. 3.

FIG. 6 shows a computer display screen corresponding to a client user interface used in a preferred embodiment of the present invention.

FIG. 7 is a flow chart showing another preferred embodiment of the present invention.

FIG. 8 is a block diagram showing the hardware used to implement the preferred embodiment of FIG. 7.

FIG. 9 shows a computer display screen used by a group member to specify a criteria template which, when matched, will cause the system to automatically process a received electronic communication.

FIG. 10 shows a computer display screen used by an electronic mail group member to specify a response either to be generated as an automatic response when the received electronic mail meets the criteria specified in the computer screen of FIG. 9 or to be generated selectively by a member of an electronic mail group responsive to an electronic mail received in the group electronic mailbox.

### DETAILED DESCRIPTION OF THE PREFERRED EMBODIMENTS

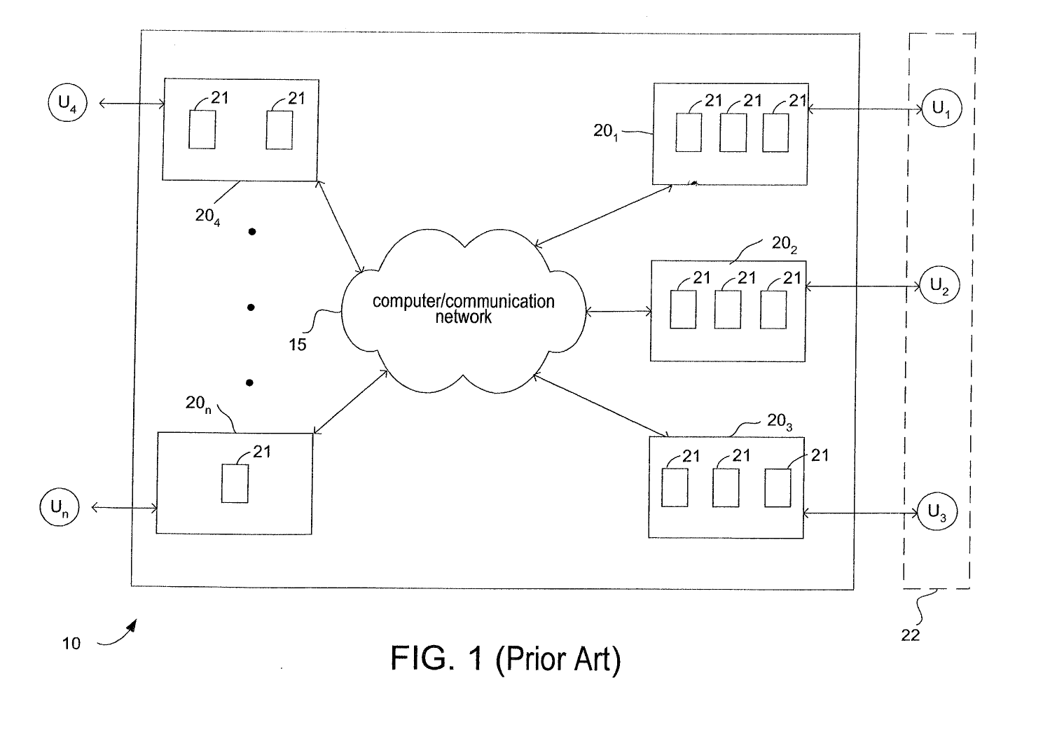

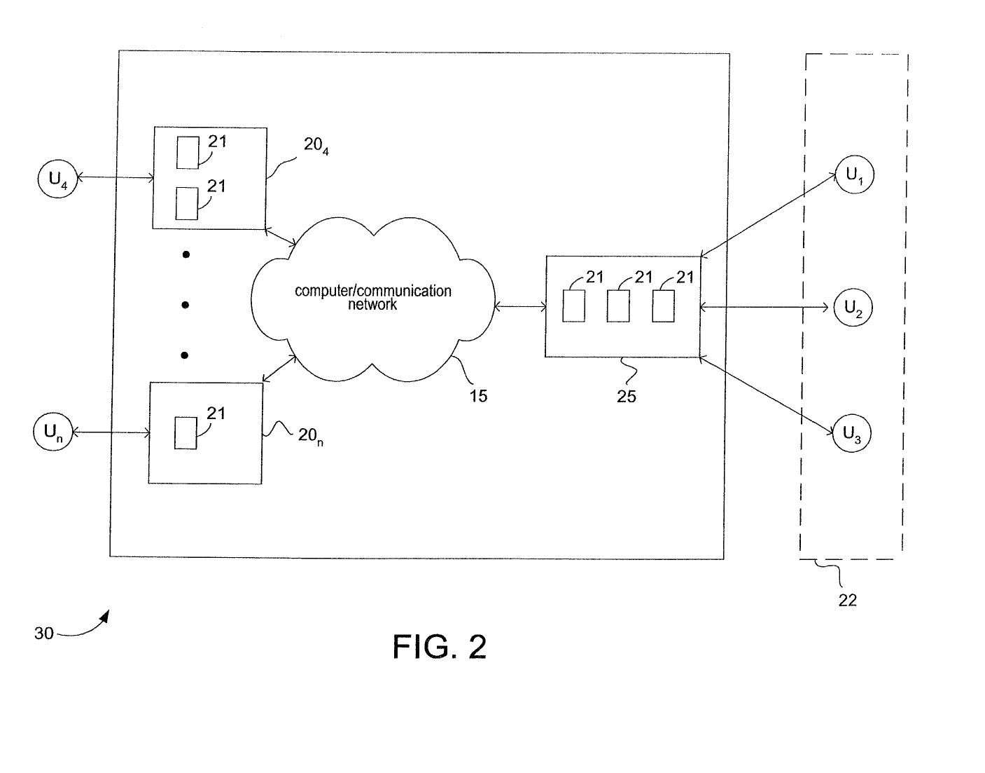

FIG. 2 is a high-level functional block diagram depicting an e-mail system 30 embodying the present invention. Elements appearing in FIG. 2 that were introduced in FIG. 1 are referred to with the same reference numerals that were originally used. E-mail system 30 comprises e-mail mailboxes 20₄-20ₙ for users U₄-Uₙ. Users U_{1, U}₂ and U₃ will each typically have an individual mailbox, as well as access to group electronic mailbox 25. Users U₁-Uₙ can electronically communicate with one another by exchanging e-mail messages over the network 15 through e-mail mailboxes 20₁, -20ₙ. By sharing group electronic mailbox 25, users U₁, U₂ and U₃ can work collaboratively and/or simultaneously with the received e-mail messages. Group electronic mailbox 25 can facilitate flexible management of workflow to accommodate vacations, absences, short-term schedule changes, and shifting or evolving work responsibilities.

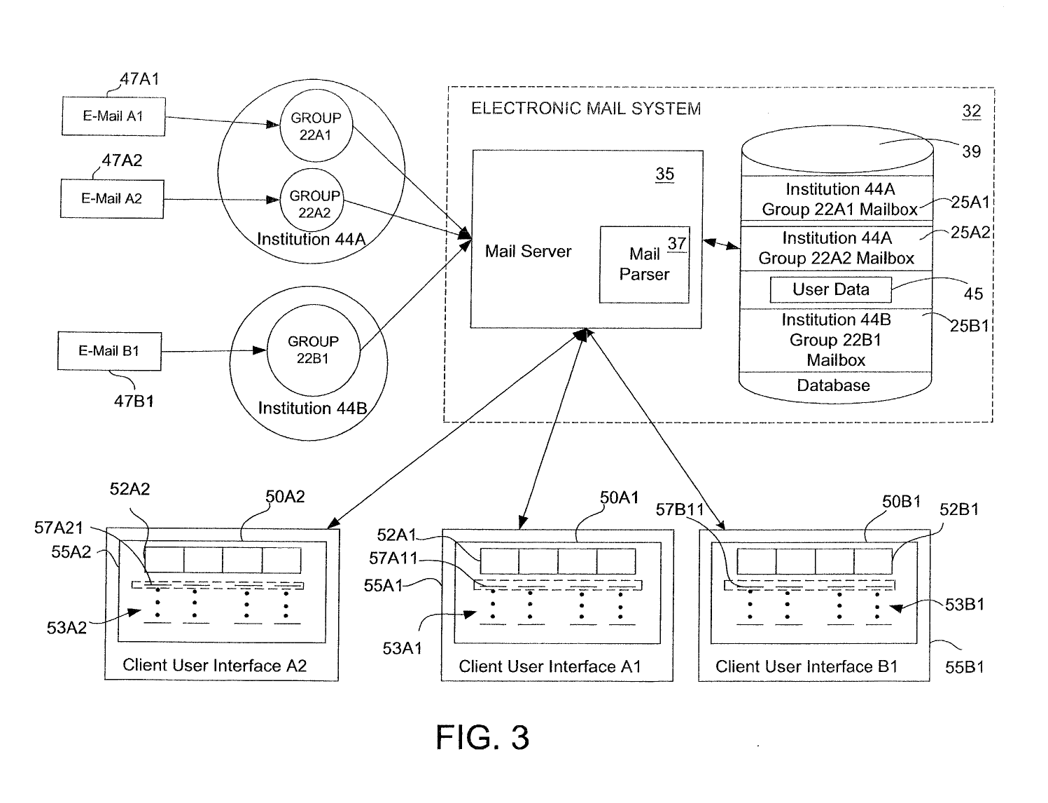

FIG.3 is a block diagram showing a preferred embodiment of an electronic mail system 32 in accordance with the present invention. The index “x” is used below to represent any number, such as x=1 or 2, and index y is used to represent a letter, such as y=A or B). Electronic mail system 32 generally includes a mail server 35, a mail parser 37, and a storage unit 39. Electronic mail system 32 that services multiple institutions 44y. In other embodiments, electronic mail system 32 may serve a single institution and be integrated into that institution's e-mail system. At mail server 35, a group electronic mailbox 25yx is configured for a corresponding group 22yx associated with one of a plurality of institutions 44y. Preferably, each group electronic mailbox 25yx serves a plurality of users that are members of a group 22yx associated with one of the plurality of institutions 44y. As shown in FIG. 3, institutions 44A and 44B are communicatively connected to electronic mail system 32 for serving users within institutions 44A and 44B. Group electronic mailboxes 25Ax and 25Bx correspond to a respective institution-identification number “institution-A-id” or “institution-B-id” for the associated groups 22Ax and 22Bx, respectively, within respective institutions 44A and 44B.

Institutions 44y receive electronic communications 47yx, typically e-mail messages, which are generally addressed to an electronic mail address for a specific office of one of institutions 44y, such as an admissions office or a financial aid office. Institutions 44y forward electronic communications 47yx to electronic mail system 32. In some implementations, electronic mail system 32 may serve a single institution. Preferably, each group electronic mailbox 25yx comprises an associated inbox 50yx for storing newly received one or more inbound electronic communications 47yx. (For clarity, inboxes 50yx are shown as displayed in user interface 55yx rather than being shown within group electronic mailboxes 25yx.) For example, groups 22A1 and 22A2 of institution 44A may receive electronic mails 47A1 and 47A2, respectively. Received electronic mails 47A1 and 47A2 are stored in associated and respective inboxes 50A1 and 50A2 of group electronic mailboxes 25A1 and 25A2. Likewise, group 22B1 of institution 44B may receive electronic mail 47B1. Received electronic mail 47B1 is stored in associated inbox 50B1 of group electronic mailbox 25B1.

Each of the client user interfaces 55yx can present a view to an active user of the corresponding group electronic mailboxes 25yx. The view includes the electronic communications 53yx which are resident in the respective inboxes 50yx. Each of the client user interfaces 55yx can enable the active user to communicate with electronic mail system 32 and includes an associated set of tools 52yx for manipulating electronic communications 53yx resident in group electronic mailbox 25yx. The set of tools 52yx performs desired functions on selected ones of the electronic communications 53yx. Users belonging to group 22yx are provided access to electronic mailbox 25yx. However, such access can be selectively limited to a subset of corresponding group 22yx or the set of tools 52yx available to different members of group 22yx may vary. Multiple users from the selected subset can concurrently share the received electronic communications 53yx.

An ordered pair comprising a user login identification and a password for each of the users within institutions 44y is stored in user data 45 within storage 39. Each ordered pair is assigned one or more permission attributes that define the user's access rights for one or more group electronic mailboxes 25yx. For example, a first permission attribute defines rights for members of group 22A1 from institution 44A to access group electronic mailbox 25A1. The first permission attribute maps each ordered pair associated with the members of the group 22A1 to a institution-identification number “institution-Al-id” corresponding to the group electronic mailbox 25A1. The members of group 22A1 are provided access to view and selectively manipulate the one or more resident electronic communications 53A1 within the group electronic mailbox 25A1. Any member of the group 22A1 can define one or more alternate delivery instructions for the one or more inbound electronic communications 53A1. For example, each member of group 22A1 can specify a match criteria in a criteria template and then define in a notification specification rules to execute in when inbound electronic communications 53A1 satisfies the match criteria. The rules can prescribe, for example, an automated response or automated forwarding or directing one or more electronic communications from the received electronic communications 53A1 to a selected mailbox other than the default inbox 50A1 of the group electronic mailbox 25A1 assigned to group 22A1.

In operation, institutions 44y forward inbound electronic communications 47yx to electronic mail system 32. On receipt of the inbound electronic communications 47yx, mail parser 37 compares the communications 47yx to stored criteria templates to determine whether or not to apply one or more user defined alternate delivery instructions. If not, electronic communication 47A1 addressed to the institution-identification number “institution-A-id” corresponding to the group 22A1 is delivered to the group electronic mailbox 25A1 and stored in inbox 50A1 of the group electronic mailbox 25A1. Once the electronic communication 47A1 is stored in group electronic mailbox 25A1, any member of the group 22A1 can view the stored electronic communication 47A1. Group electronic mailbox 25A1 is accessed and operated by a member of the group 22A1 having permission to access the group electronic mailbox 25A1. Any member of the group 22A1 can determine an appropriate response or an action responsive to the receipt of electronic communication 47A1. For example, electronic communication 47A1 is processed by an individual member of group 22A1 who selects one or more actions from set of tools 52A1 that perform desired functions. Alternatively, electronic communication 47A1 can be processed automatically by electronic mail system 32 for example, by sending an electronic response to the originator.

The active member of the group 22A1 requesting access to the group electronic mailbox 25A1 provides via the client user interface 55A1 an ordered pair of the user login identification and the password. The ordered pair of the user login identification and the password is directed to mail server 35. Mail server 35 compares the provided ordered pair of the requesting member with a pre-stored ordered pair of user data 45 to map it to an associated institution-identification number. One or more stored electronic communications 53A1 are retrieved from the group electronic mailbox 25A1 in storage 39. Mapping from the user provided ordered pair to the associated institution-identification number enables mail server 35 to retrieve the stored electronic communications 53A1 from the storage 39. The retrieved one or more electronic communications 53A1 are displayed within inbox 50A1 of group electronic mailbox 25A1 through client user interface 55A1. Group electronic mailbox 25A1 display includes a view of inbox 50A1 containing electronic communications 53A1. The set of tools 52A1 provides within the group electronic mailbox 25A1 an ability to the members of the group 22A1 to selectively operate on the displayed electronic communications 53A1. The view of the group electronic mailbox 25A1 includes an associated status and one or more attributes derived from each of electronic communications 53A1 to identify a profile associated with the electronic communications 53A1.

In one embodiment, group electronic mailbox 25yx includes a status indicator 57yxz for each of the one or more electronic communications 53yx, index z can be any integer for indexing status indicators). Status indicators 57A1z convey the status information regarding the associated one or more electronic mails 53A1 to the members of group 22A1. Status information includes, but is not limited to, read information, acted upon information, and replied information. In response to acts by one member of group 22A1 that cause a status change, a signal is transmitted to update the associated status indicator 57A1 for any other group member viewing the status indicator 57A11.

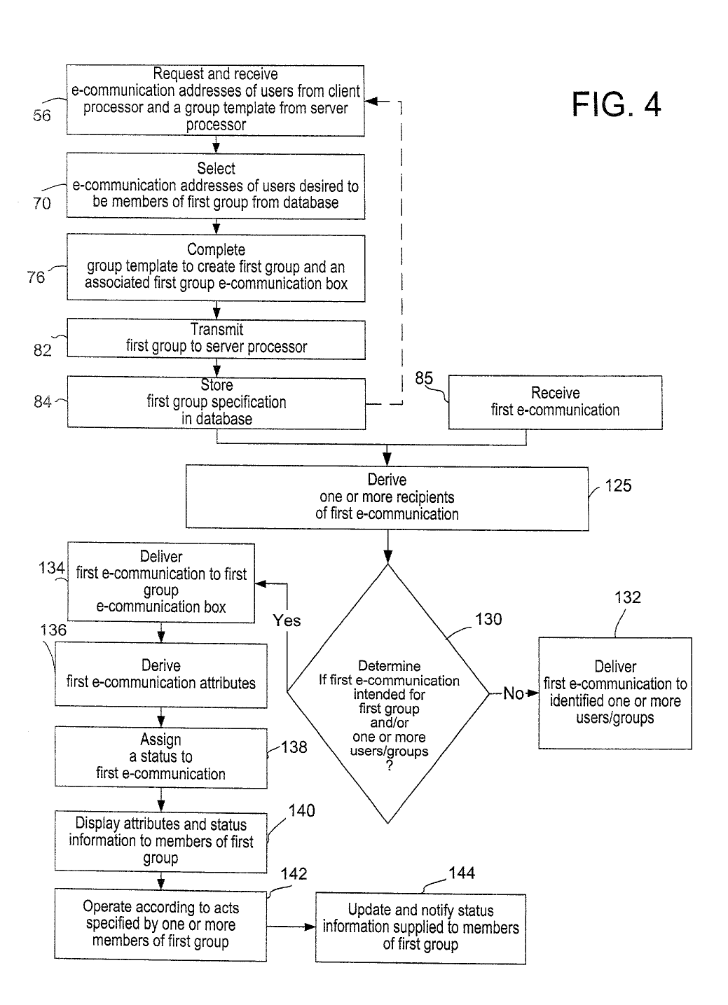

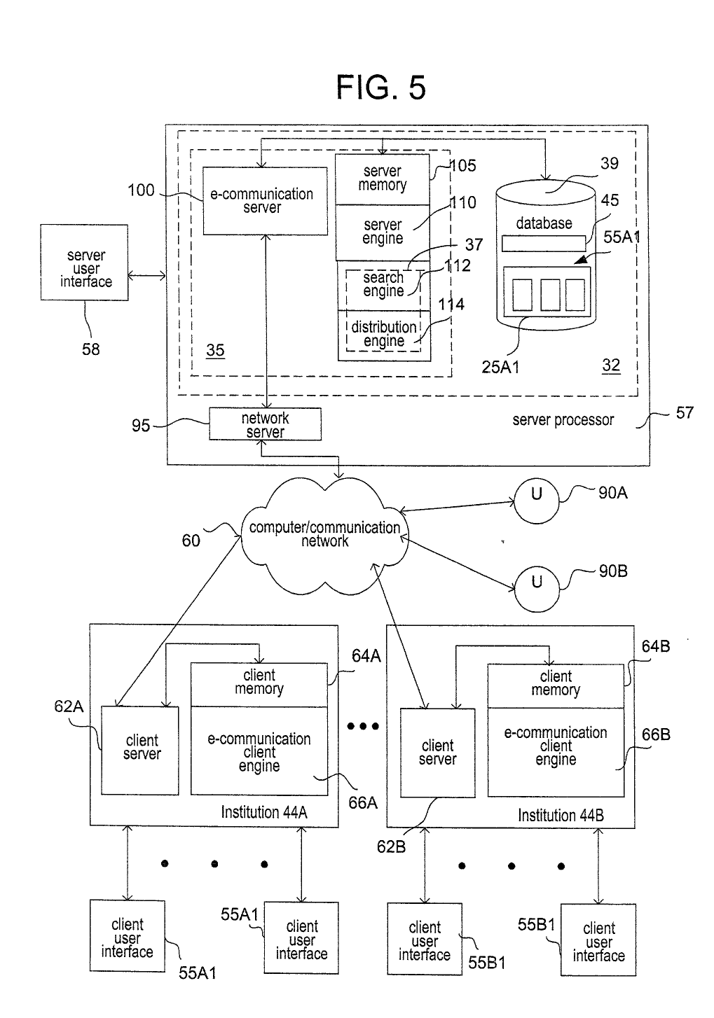

FIG. 4 shows a flow chart of the steps of a method of group electronic mailbox consistent with the present invention. FIG. 5 is a block diagram to implement the method of group electronic mailbox consistent with the embodiment of FIG. 4. With reference to FIGS. 3, 4 and 5, in step 56, a first user requests and receives a group template from a server processor 57 via a server user interface 58 to create group 22yx. The requested group template can be a blank group template for creating a new group or a previously created group template for editing can be requested from server processor 57. For example, over a computer/communication network 60, a group 22A1 specification including but not limited to, addresses of multiple users of group 22A1, is received from a client electronic communication server 62A representing a central processing unit of institution 44A. The group 22A 1 specification comprises identifying information for each of the member of group 22A1 and a corresponding group identifying information to associate group 22A1 with group electronic mailbox 25A1. The group 22A1 specification generally includes user login information and password information for the members of the group 22A1. Preferably, server processor 57 services institution 44A via computer/communication network 60.

With continuing reference to FIG. 3, a plurality of client user interface devices 55A1 are operably connected to client server 62A of institution 44A. This enables the group 22A1 users to interact with client server 62A through the plurality of client user interfaces devices 55A1. The plurality of the client user interface devices 55A1 may be personal computers, or “dumb” terminals generally comprising a display, a keyboard, and a mouse. However, preferably the client user interface devices could include any suitable Internet web interface device that can be associated with remotely located computers connected in a network configuration, such as in a local area network or other suitable configurations that can be used to access computer/communication network 60.

Client server 62A associated with institution 44A executes a client portion of communications software to communicate over computer/communication network 60 to server processor 57. Client server 62A includes a client memory 64A that contains client software used in the present invention, including an e-communication client engine 66A, such as an electronic mail client package. Likewise, client server 62B associated with institution 44B executes a client portion of communications software to communicate over computer/communication network 60 to server processor 57. Client server 62B includes a memory 64B that contains client software used in the present invention, including an e-communication client engine 66B, such as an electronic mail client package. Moreover, a plurality of client user interfaces 55B1 are operably connected to client server 62B of institution 44B. This enables the group 22B 1 users to interact with client server 62B through the plurality of client user interfaces 55B1.

In step 70, the first user selects from storage 39 e-communication addresses of user account holders desired to be members of group 22A1 within institution 44A. In step 76, the first user completes the group template to create group 22A1 with a corresponding group 22A1 identification number. Subsequently, the associated group e-communication mailbox 25A1 is created by the communications software. To create group 22A1, the first user may use the group template to specify a collection of individual electronic mail addresses, nicknames later resolved to addresses, or distribution lists. Group 22A1 may include, for example, managers of a particular level in a business organization or members of a particular task force, or office staff of an admissions office or financial office within institution 44A. Preferably, group 22A1 e-communication mailbox 25A1 is created by including a group list to store the individual electronic mail addresses of the selected members for group 22A1. Each individual electronic mail address is independently assigned to the group 22A1 identification number with which the group 22A1 electronic mailbox 25A1 is associated.

In one embodiment, institution 44A may include an admissions office and a financial aid office having email addresses “admissions@institutionA.edu” and “financialaid@institutionA.edu,” respectively. The addresses “admissions@institutionA.edu.” and the “financial-aid@institutionA.edu” for the admissions and financial aid offices correspond to an institution-identification numbers “institution-A-ids” at server 35 in system 32. For example, the “institution-A-ids” could be 2001@esponse.college.com and 2005@esponse.college.com. Institution-identification number 2001@esponse.college.com and 2005@esponse.college.com correspond to group 22A1 and group 22A2 at institution 44A, respectively, such as an admissions group (AGIA) and a financial aid group (FAGIA).

More specifically, in one embodiment of the present invention of FIG. 3, electronic communications 47A1 and 47A2 may be addressed to the admissions office (“admissions@institutionA.edu”) and the financial aid office (“finacial-aid@institutionA.edu”). Group electronic mailboxes 25A1 and 25A2 correspond to institution-identification numbers 2001@esponse.college.com and 2005@esponse.college.com. Electronic mails 47A1 and 47A2 are generally received at institution 44A and then forwarded to mail server 35. In electronic mail system 32, electronic mails 47A1 and 47A2 arrive at mail server 35 addressed to institution-identification numbers 2001@esponse.college.com and 2005@esponse.college.com. Mail parser 37 determines delivery of the electronic mails 47A1 and 47A2 to respective group electronic mailboxes 25A1 and 25A2 of groups 22A1(AGIA) and 22A2 (FAGIA).

Similarly, institution 44B may include an admissions office having email address “admissions@institutionB.edu.” The address “admissions@institutionB.edu.” for the admissions office corresponds to an institution-identification number “institution-B-id” at server 35 in electronic mail system 32. For example, for mail server 35 with an address “esponse.college.com,” the “institution-B-id” could be 1001@esponse.college.com. Institution-identification number 1001@esponse.college.com corresponds to group 22B1, such as an admissions group (AGIB) in institution 44B.

One of ordinary skill in the art will appreciate that the underlying process of creating groups 22yx e-communication mailboxes 25yx is similar to the process employed in known systems to obtain an associated e-communication mailbox, such as an e-mail mailbox for a user account name. For example, in a typical e-mail system, when a new user account is created for a designated user, a unique user email address and a corresponding user e-mail mailbox is created and stored in the e-mail system.

The completed group template that was requested in step 56 from server processor 57 is transmitted in step 82 back to the server processor 57. In step 84, the group 22A1 specification including the group 22A1 identification number and corresponding e-communication mailbox 25A1 is stored in storage 39. Multiple first users can typically complete multiple group templates instep 56 and transmit them to server processor 57 for storage in storage 39. This is shown in FIG. 4 by the dashed line returning from step 84 to step 56. Group 22A1 users could be part of a single enterprise and connected to server processor 57 over a local area network or a wide area network, or an Intranet. Alternatively, server processor 57 could service many unrelated users, each having potential interest in the content of e-communications being directed to server processor 57 which is connected to client server 62A through computer/communication network 60, such as a computer network including the Internet. E-communications generally comprise an item content and an item profile. The item content portion of e-communications may include an e-mail message or electronic notification or electronic response with or without attachments, such as documents, spreadsheets, executable programs, voice, video, etc. The item profile typically includes item attributes to identify item characteristics and a distribution specification. The item profile is used to perform appropriate initial processing of the e-communications. For example, item distribution specification is derived to determine the one or more intended recipients of the particular e-communication. The use of such item profiles to readily process e-communications is well known in the art.

In step 85, a first e-communication, such as electronic mail 47A1, having a first distribution specification included in the item profile is received in server processor 57 from institution 44A client server 62A over computer/communication network 60. Typically, many such e-communications from a variety of sources are continually received at client server 62A. For example, users 90A, 90B using a computer communicatively connected to computer/communication network 60 can send the first e-communication 47A1 to institution 44A serviced by server processor 57. However, the first e-communication 47A1 may have one or more intended recipients other than group 22A1.

Server processor 57 comprises a network server 95 executing communications software to communicate over computer/communication network 60. In addition, server processor 57 includes electronic mail system 32. Preferably, electronic mail system 32 having mail server 35 includes an e-communication server 100 in data communications with network server 95 having a server memory 105 that contains software used in the present invention including an e-communication server engine 110, a search engine 112, and a distribution engine 114. Server memory 105, such as one or more hard disk drives, allows the processor 58 to store information needed to provide its services to the client servers 62A and 62B. Moreover, storage 39 having group electronic mailboxes 25yx including group e-communication mailbox 25A1 and user data 45 are accessible to mail server 35.

E-communication server engine 110 and network server 95 enables the client servers 62A and 62B to access data stored in the storage 39. E-communication client engine 66A in the client server 62A passes data to and from the server 95 and provides the relevant data to the users of group 22A1 via the client user interfaces 55A1. Data stored on the storage 39 also may be stored on the client server's 62A client memory 64A for use by the e-communication client engine 66A. Search engine 112 provides a search function capability to users of institutions 44A and 44B. The search function allows a user to perform search on user data 45 including the user e-communication addresses. Search engine 112 also provides mapping functionality to setup groups for or among the users of institution 44A or institution 44B. Distribution engine 114 parses e-communication 47A1 to determine the intended recipients from the respective distribution specification included in the item profile.

E-communication server engine 110, search engine 112 and distribution engine 114 are generally executed by server processor 57 to process the inbound and outbound network traffic information associated with the e-communications 47yx. Engines 110, 112, and 114 allows users of groups 22yx to store electronic mail 47A1 and retrieve corresponding electronic mail 53A1 based on criteria predefined by the users of the group 22A1.

The server processor 57 also includes a storage location or address in storage 39 comprising a set of entries associated with the set of e-communication entities. When e-communication 47A1 arrives in mail server 35 it is parsed by mail parser 37 and stored in a specific storage location in storage 39. It is marked for which institution it belongs to and what mailbox it's currently in. This allows users of group 22A 1 to employ a web browser through client user interface 55A1 to access e-communication 47A1. In one embodiment, a SQL database is used to store e-communications 47xy in storage 39. One or more tables store the received e-communications 47xy in associated e-communications 53xy. Preferably, a row on the table is tagged according to the institution identification number and the associated mailbox for each of the electronic communication 47xy. For example, for mail server 35 with an address “esponse.college.com,” a row for the first e-communication 47A1 on the table is tagged according to the institution identification number 2001@esponse.college.com and the associated group e-communication mailbox 25A1.

In step 125, one or more recipients of the first e-communication 47A1 are derived from the distribution specification included in the item profile. In step 130, the intended recipient or recipients of the first e-communication are determined. When the first e-communication is received by server processor 57, e-communication server engine 110 performs generally known parsing functions on the item profile of the e-communication in order to deduce the intended recipient's institution identification number such as “2001”. The institution identification number is used to identify the recipient's e-communication mailbox address. For example, if the communications software in step 130 determines that the distribution specification does not include the first group 22A1 institution identification number “2001”, in step 132 server processor 58 delivers the first e-communication to another identified recipient's or recipients' e-communication mailbox addresses. If the communications software in step 130 determines that the distribution specification includes the first group institution identification number “2001”, in step 134 server processor 58 delivers the first e-communication 47A1 to first group e-communication mailbox 25A1 address of storage 39 where it is stored as item 53A1.

In a preferred embodiment of the invention, client servers 62A or 62B do not perform parsing functions when e-communications 47yx are received. Parsing of the e-communications 47yx is performed at the server processor 57. However, client servers 62A or 62B are not precluded from performing some processing. In one embodiment, client servers 62A or 62B perform some predetermined processing of the inbound and outbound e-communications. For example, a processing function to account for differences in character set coding standards between systems can be provided in client servers 62A or 62B. Thus, if the American Standard for Information Exchange (“ASCII”) format is used, a conversion function may be provided to convert text formatted differently, such as according to the Extended Binary Coded Decimal Interchange Code (“EBCDIC”).

To access e-communication items 53A1 resident in the first group e-communication mailbox 25A1, client user interface 55A1 can be used. The received e-communication items 53A1 are generally kept in the first group inbox 50A1 associated with the first group e-communication mailbox 25A1. For each member of the first group 22A1, a copy of the first group inbox 50A1 is provided to access the first group e-communication mailbox 25A1. For example, any member of the first group 22A1 may request to view the e-communication items 53A1 resident in first group e-communication mailbox 25A1. To present the first group inbox 50A1 having the first e-communications 53A1 to the requesting member, in step 136, the communications software derives a predetermined set of item attributes for the first e-communications 53A1. The set of derived attributes may include, but not limited to, identification of the sender and recipient(s), the title or subject, and/or any other either specifically requested or relevant information of the first e-communications 53A1. In step 138, a status is assigned to the first e-communications 53A1 to indicate to the requesting member the state of the first e-communications 53A1.

In step 140, for the requesting member of the first group 22A1, a list or an inbox list is displayed to present the first e-communications 53A1 for selective manipulation of the first e-communications 53A1. The inbox list includes one or more received e-communication items 53A1 appearing within the first group inbox 50A1 of the first group e-communication mailbox 25A1.

To access and/or operate on one or more e-communication items from the first group e-communication mailbox 25A1 any member of the first group 22A1 may request a display of the inbox list. E-communication items 53A1 along with the associated set of derived attributes and status using status indicators 57A1x are displayed in the opened or accessed first group inbox 50A1. The set of tools 52A1 having typical actions or e-communication managing tools is also presented to the requesting member. The requesting member can choose to apply instructions to operate on the e-communication items 53A1 resident in the first group inbox 50A1. An action from a member of the first group 22A1 governs a type of desired operation on one of the received e-communication items 53A1. The actions enable a member of the first group 22A1 to perform a number of functions such as, receiving, sending, composing, forwarding, storing, and retrieving text, graphics, images, audio or video data. In step 142, the type of the operation is determined, in accordance with the applied instruction. For example, the instruction may indicate whether the e-communication item among the received e-communication items 53A1 is to be deleted or replied to.

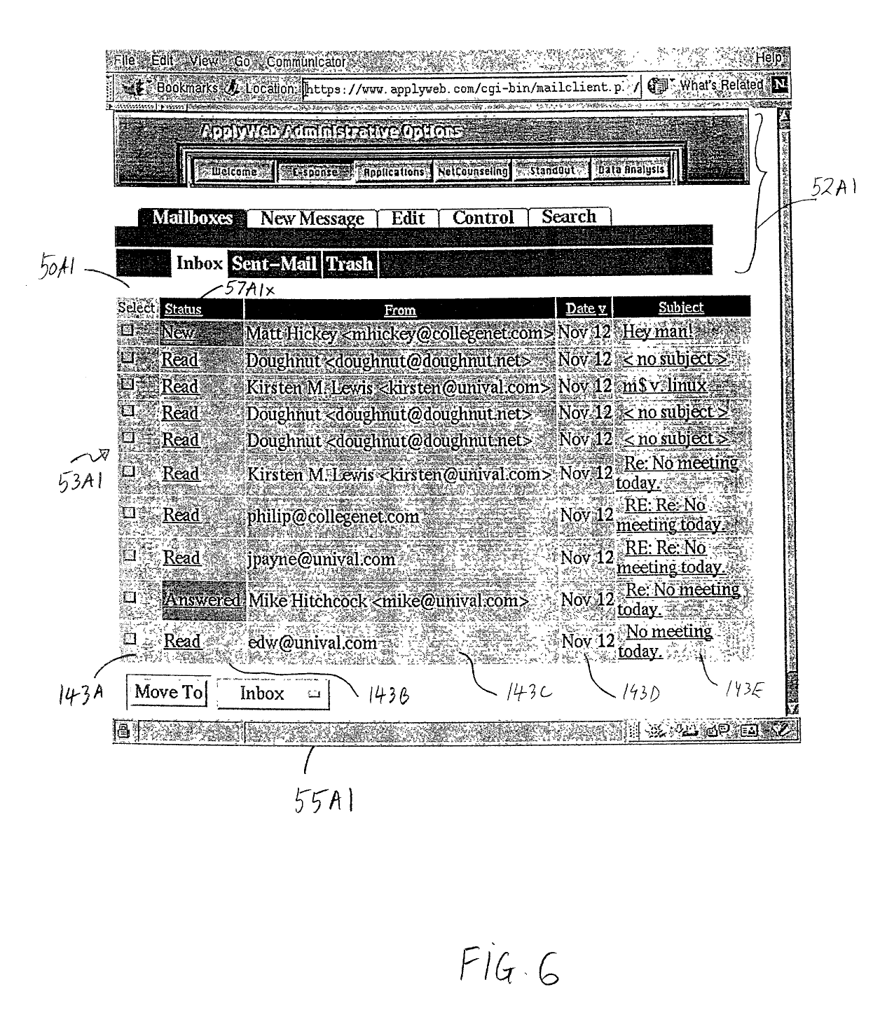

FIG. 6 shows a computer screen which correspond to client user interface 55A1 depicting an exemplar first group 22A1 inbox 50A1 with an example of inbox list comprising received electronic mails 53A1 that would be presented upon such a request. Inbox 50A1 comprises set of tools 52A1 for user actions. As shown in FIG. 6, the inbox list comprises five columns. A first column 143A enables group 22A1 members to select and indicate the choice of a selected electronic mail item among received e-communication items 53A1. A second column 143B includes status indicator 57A1x to identify the status of electronic mails 53A1. A third column 143C identifies the sender of the electronic mails 53A1 shown in inbox 50A1. A fourth column 143D lists the receipt date of the electronic mails 53A1 while a last column 143E identifies the electronic mail subject or a short title description of the electronic mails 53A1. Near the top of the depicted inbox list of electronic mails 53A1, set of tools 52A1 include as an example of a menu and near the bottom of the inbox list, exemplary operations for applying instructions to perform appropriate functions for managing the first group 22A1 electronic mailbox 25A1. For example, in one embodiment the computer screen of FIG. 6 may be a window on a display screen for displaying to a member the menu including a plurality of user selectable action items in which the action items represent instructions to perform appropriate functions for managing the first group 22A1 electronic mailbox 25A1.

In step 144, the first group inbox 50A1 is updated to reflect any changes or modifications to the status of the received e-communication items 53A1 in response to any members of group 22A1 applying instructions to one or more received e-communication items 53A1 in step 142. A group member may be notified by appropriate updating or refreshing of the first group inbox 50A1 display presented to the member. For example, the first group inbox 50A1 may be updated each time a group member of the first group 22A1 returns to the first group e-communication mailbox 25A1, such as, from reading another e-communication therein. Alternately, it can be updated automatically in response to a change effected by any member of the first group 22A1. However, the latter implementation could result in excessive updating of the first group e-communication mailbox 25A1.

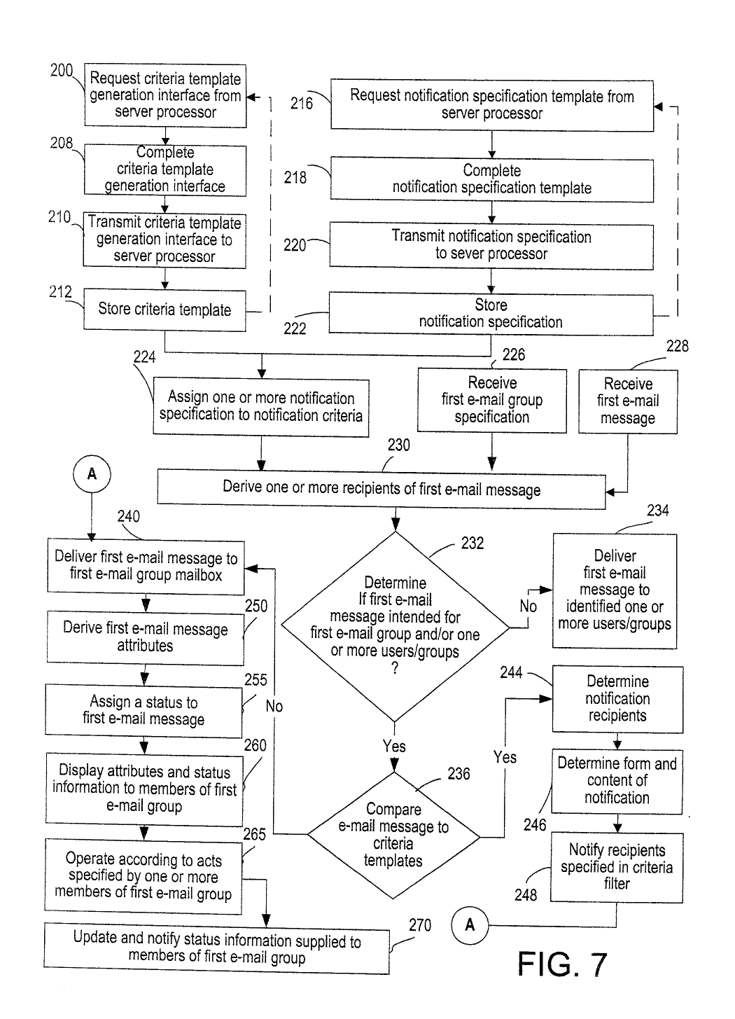

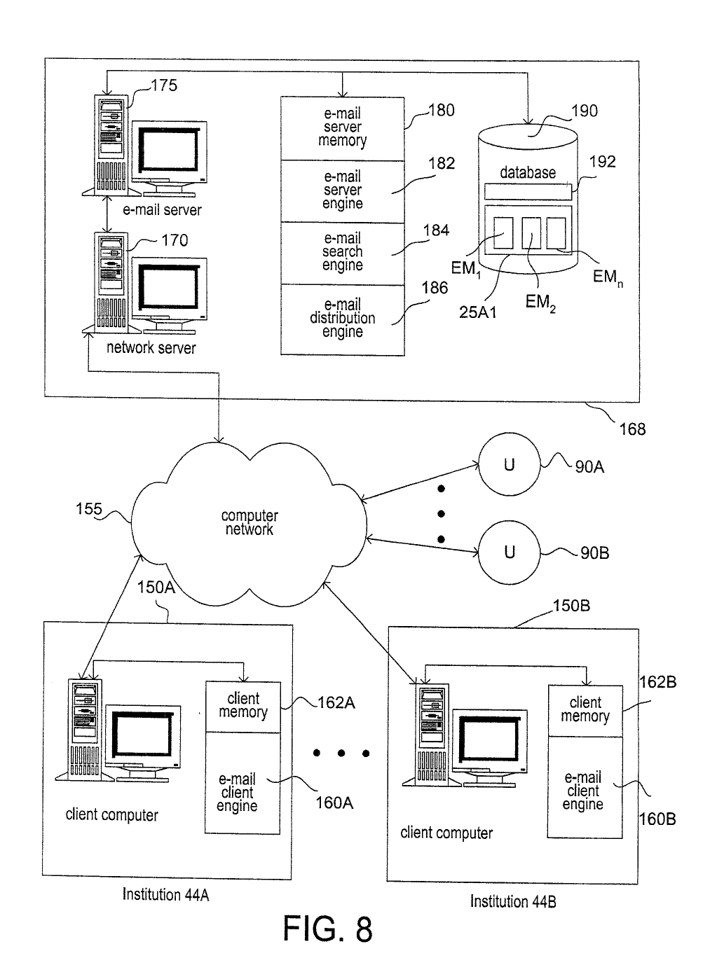

FIG. 7 is a flow chart showing the steps of another preferred group electronic mailbox method consistent with the present invention. FIG. 8 shows hardware and electronic mail software used to implement this preferred group electronic mailbox method consistent with the embodiment of FIG. 7. The flow chart of FIG. 7 shows an embodiment in which one or more recipients are notified by a predefined notification either automatically according to a notification specification when the profile and/or the content of a received e-mail matches the criteria template or selectively by a member of an e-mail group in response to an e-mail received in the member's group mailbox.

With reference to FIGS. 7 and 8, a client central processing unit at institution 44A is implemented using a client computer 150A. Likewise, a client central processing unit at institution 44B is implemented using a client computer 150B. Client computers 150A, 150B could be an IBM compatible computer or a Macintosh personal computer, connected over a computer network 155, such as the Internet for users of groups 22yx. For example, client computer 150A can be employed by e-mail user account holders including members of an e-mail group such as group 22A1 of institution 44A.

Client computer 150A includes client memory 162A which contains a client portion of the e-mail software. The client e-mail software includes an e-mail client engine 160A to operate locally on the e-mail message traffic for the communicating user account holders from one or more client computers 150A. E-mail client engine 160A enables client computer 150A to communicate with a server central processing unit 168. Client computer 150A also enables the user account holders to view and manipulate the received e-mail messages. Likewise, client computer 150B includes client memory 162B which contains a client portion of the e-mail software. The client e-mail software includes an e-mail client engine 160B to operate locally on the e-mail message traffic for the communicating user account holders from one or more client computers 150B. E-mail client engine 160B enables client computer 150B to communicate with server central processing unit 168. Client computer 150B also enables the user account holders to view and manipulate the received e-mail messages.

An e-mail server portion of the e-mail software is resident in the server central processing unit 168 for client computers 150A, 150B, and any other clients to send and receive e-mail messages. At server central processing unit 168 is a network server 170, such as a Sun Solaris Ultra Sparc Server, executing network communications software, such as Apache HTTPD Server from The Apache Group, www.apache.org, to communicate over computer network 155. Also at processor 68 is an e-mail server175, in data communications with network server 170 and having a memory 180 that contains the e-mail server portion of the e-mail software used in the another preferred embodiment of the present invention. The e-mail server software includes an e-mail server engine 182, an e-mail search engine184, and an e-mail distribution engine 186. A storage 190, which contains data from the criteria templates and information submitted on e-mails is in data communications with e-mail server 175. The software operating on the e-mail server 175 and network server 170 communicate with each other and with necessary databases using standard protocols, such as CGI or Apache API. Skilled persons will understand that additional servers may be used.

Within storage 190, server central processing unit 168 maintains e-mail user account data 192 and e-mail storage area (mailbox 25yx) for each user account holder and/or for any other groups 22yx. An e-mail group may be formed, for example, by a user account holder following the steps 56, 70, 76, 82, and 84 of FIG. 4. For example, group e-mail mailbox 25A1 is created when the first e-mail group 22A1 is formed, in accordance to a similar process illustrated with reference to creation of the first group 22A1. Preferably, group e-mail mailbox 25A1 is created and maintained in storage 190. E-mail messages EM₁-EMₙ generated and received by e-mail group 22A1 in group e-mail mailbox 25A1 are stored in storage 190. These e-mail messages can be viewed with the user interface of the client computer 150A through the e-mail client engine 160A.

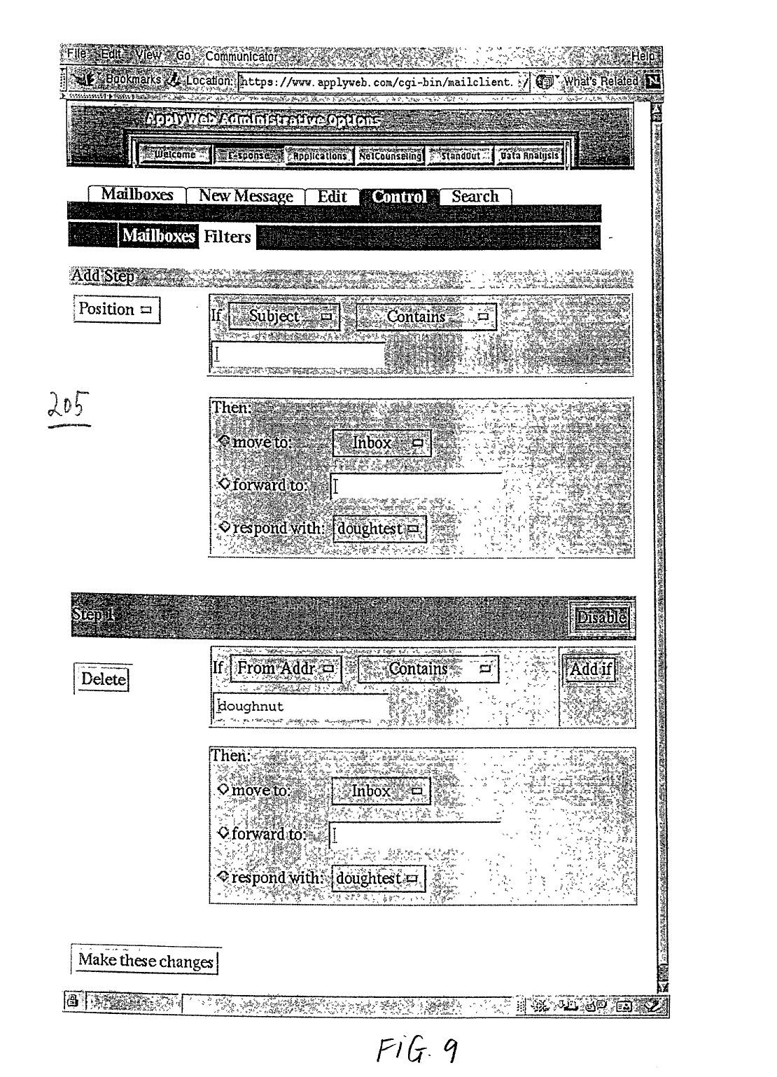

With reference to FIGS. 4 to 8, in step 200, an e-mail group member or an e-mail user account holder of group 22A1 requests a criteria template generation interface through client computer 150A. The criteria template generation interface is used to define match criteria for a criteria template and is described in the Hickey et al. patent application for “Automatic Data Transmission in Response to Content of Electronic Forms Satisfying Criteria,” filed Nov. 1, 2000 concurrently herewith. FIG. 9 shows a computer screen used by the e-mail group member of group 22A1 to specify a notification specification within a typical criteria template 205 to automatically process or respond to a received e-mail message. In step 208, the e-mail group member completes the criteria template generation interface to define a criteria template, which specifies the attributes of an item profile and/or the item content of a received e-mail that will generate an automatic notification.

FIG. 9 shows that the e-mail group member in this example has defined a criteria template entitled “doughtest” in which any received e-mails with “doughtest” in their e-mail address attribute meet the match criteria. Other fields, such as “Subject,” that are not specified by the e-mail group member in defining the criteria template will not disqualify a received e-mail from satisfying the match criteria. There is typically a field in the criteria template corresponding to each attribute in the item profile of the received e-mail, so any information in the item profile can be used for matching.

In step 210, the completed criteria template generation interface requested in step 200 from server central processing unit 168 is transmitted or posted back to server central processing unit 168. In step 212, the information provided from criteria template generation interface 205 is stored as a criteria template in storage 190 to automatically process or respond to the received e-mails according to a notification specification associated with the criteria template. Multiple e-mail group members or a moderator of the e-mail group 22A1, such as a manager of a project team or a person in charge of recruiting students in an academic institution will typically complete multiple criteria template generation interfaces to create multiple criteria templates. This is shown in FIG. 7 by the dashed line returning from step 212 to step 200.

In step 216, the e-mail group member requests from client computer 150A a template to define a notification specification that describes, either explicitly or by rules, the form and content of each notification and the notification recipients. The e-mail group member can specify multiple recipients, with customized notification content for each. Notification of the multiple recipients can be contingent on the value of a single attribute in the item profile. Multiple recipients can also be determined by data in different fields, although multiple templates can be used for such situations. For example, one of the recipients may be the e-mail group member who defined the criteria template. In step 218, the e-mail group member completes the notification specification template.

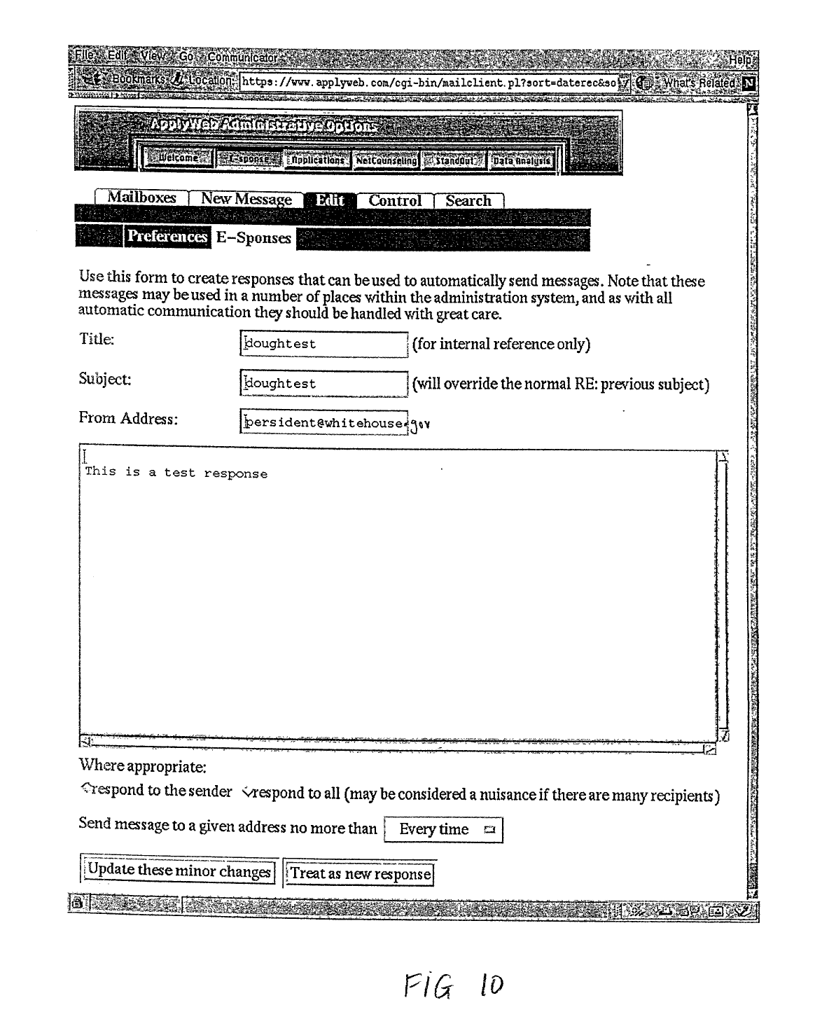

FIG. 10 depicts a computer screen used by an e-mail group member to define a notification specification or a response entitled “doughtest.” FIG. 10 shows that an e-mail will be sent to “president@whitehouse.gov” whenever the “doughtest” response is invoked. In step 220, the notification specification is transmitted to the e-mail server processor 168, and in step 222, the notification specification is stored. Typically, many such e-mail group members may complete or edit electronic notification specification templates for storing them in storage 190, as shown by the dashed line from step 222 back to step 216.

After criteria templates and notification specifications are created, one or more notification specifications can be assigned to the criteria template in step 224 to determine the notification that occurs when the match criteria is met. For example, the e-mail group member of group 22A1 assigns the notification specification entitled “doughtest” to the criteria template entitled “doughtest.”

In step 226, an e-mail group specification is received for the first e-mail group 22A1 created by following the steps 56, 70, 76, 82, and 84 of FIG. 4. Multiple individuals are typically continually composing e-mails on a variety of computers and networks and sending the e-mails through the Internet 155 to server central processing unit 168. In step 228, a newly sent e-mail message is received from an individual with access to an e-mail account. For example, e-mail arrives in the e-mail system at server central processing unit 168 via SMTP. However, other protocols may be employed to forward e-mails to server central processing unit 168 from institutions 44A and 44B. Steps 230,232, and 234 follow a similar process of the respective steps 125, 130, and 132 of FIG. 4. However, if result at step 232 is affirmative, in step 236, the newly sent e-mail message is compared to all the criteria templates created by the e-mail group member and/or other users of group 22A1. Each e-mail message that is received is compared against all criteria templates stored in storage 190. If the received e-mail message does not meet any of the stored criteria, the software delivers in step 240, the newly received e-mail message to group e-mail mailbox 25A1 for additional processing.

For each received e-mail message that satisfies a stored criteria template, one or more notifications are sent to recipients. In step 244, the software determines the recipients specified in the notification specifications assigned to the criteria template. The recipients may include the e-mail group member, another person explicitly specified in the notification specification, or a person determined in accordance with instructions specified in the notification specification and dependent upon the item content or the item profile. In step 246, the software determines the form and content of the notification. The notification content can include information from the received e-mail message. Alternatively, an e-mail composed in a conventional manner can be sent by any member of the e-mail group responsive to the newly received e-mail message. In step 248, the notification is transmitted to the recipients. After step 248, the software delivers in step 240, the newly received e-mail message to group e-mail mailbox 22A1 for additional processing. Steps 250, 255, 260, 265, and 270 follow a similar process of the respective steps 136, 138, 140, 142, 144, and 144 of FIG. 4.

In one embodiment of the present invention, a shared group mailbox is provided within an e-mail system for a group of users to jointly manage and respond to received e-mails, such as e-mail messages or e-mail items. The group mailbox generally comprises separate storage areas (e.g., inbox, sent-mail, and trash) for maintaining sets of e-mail items or messages. The separation of e-mail items is preferably done according to a status assigned to each of the e-mails. Such e-mails are generally received in the inbox storage area of the shared group mailbox. The group mailbox includes tools that allow the group members to selectively operate on the received e-mails. For example, group members can selectively access, reply to, or delete the e-mails. The group mailbox is preferably simultaneously accessible to the members of the group. The group mailbox also includes for each e-mail a status indicator to indicate the status of the e-mail to the members associated with the group. The status indicator includes specific status information to identify previous activity by individual group members for each resident e-mail of the group mailbox.

The status indicator shows the current status (e.g., New, Read, Answered, Moved, etc.) of an e-mail message in the group mailbox. Accordingly, the group mailbox provides specific status information of e-mail items that have been previously read, answered, etc. For example, an e-mail message may have been read and answered by a first group member. If a second group member selects or opens the message, specific status information could indicate that the first group member had read the message, replied to it (possibly identifying a standard reply e-mail message that had been sent), and when the message had been read and replied to. The inbox of the group mailbox is updated periodically for each member of the group as the e-mail messages are processed by individual members.

In one embodiment, the group mailbox may also include notification specifications to automatically process or respond to the received e-mails according to a predetermined criteria templates. The group mailbox can also include one or more predefined reply messages that can be sent by any member of the group or may be sent automatically according to a notification specification. A reply message template can be provided to create reply messages as responses. Messages that are sent automatically, called E-Sponses, may be sent to the original sender as a reply, or may be sent to another person or group. Conversely, group members may compose e-mail messages in a conventional manner. The group mailbox can receive any e-mail messages, including e-mails from individuals (e.g., students, prospective students, etc.) and automatic e-mail messages generated as an E-Sponse™ by another e-mail generation system.

Additionally, such an automatic e-mail can be in response to content in a non-mail protocol communication, such as an electronic form posted using hypertext transport protocol (HTTP). Electronic forms can be used by students to submit and edit student profile page. Electronic forms can also be used by a group member to define a criteria template and define a notification to be generated as the automatic response to the received e-mail or to content in a non-mail protocol communication. In one embodiment, an electronic form is submitted over a computer network such as the Internet by an Internet user. The electronic form can be a student profile page in the Standout® system. A forms engine, such as the Universal Forms Engine described in U.S. patent. application Ser. No. 09/325,533, can be used for generating and processing such electronic forms.

Server central processing unit 168 could be within a recruiter's college, that is, the system can be implemented as a stand alone service of a single institution. Preferably, however, the present invention is implemented as part of an overall system in which a third party processor, such as server central processing unit 168 makes student profiles available to multiple institutions and provides additional services to students and institutions, such as applications processing. An example of a system serving multiple institutions is the ApplyWeb® system from CollegeNET, Inc., the assignee of the U.S. patent application Ser. No. 09/325,533 application. Information on various forms, such as student profiles and admissions applications, processed by server central processing unit 168 are preferably shared among forms used in the various services provided by the third party administrator, so that information entered once by the student, unless specified otherwise, is automatically available and inserted into forms in other services.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method for assisting members of a group to share electronic communication information, the method comprising:
receiving a group specification, the group specification comprising identifying information for each member of the group and a corresponding group identifying information to associate the group identifying information with a group mailbox;
receiving inbound electronic communication information comprising one or more electronic communications from a remote connection over a communication network, said each electronic communication comprising a distribution;
processing said distribution to derive distribution information for one or more recipients of the electronic communication, said distribution information comprising recipient identification information;
determining from the recipient identification information one or more intended recipients of the electronic communication; and
directing the group intended electronic communication to the group mailbox wherein said group mailbox being shared by the members of the group.

2. The method of claim 1 in which the identifying information for each member of the group is an electronic address and the identifying information for the group is a group identification number.

3. The method of claim 1 in which the group comprises a list of identifying information of the members of the group.

4. The method of claim 1 in which the group mailbox comprises separate storage areas for maintaining sets of electronic communications.

5. The method of claim 1 in which the electronic communication information comprises one or more electronic mail messages.

6. The method of claim 1 in which directing the group intended electronic communication includes delivering the received one or more electronic communications to an inbox of the group electronic mailbox.

7. The method of claim 1 in which directing the group intended electronic communication includes deriving from an item profile of each of the received electronic communications a plurality of attributes to identify sender identifying and item associated information.

8. The method of claim 1 in which directing the group intended electronic communication includes assigning a status to each of the received electronic communications to indicate the status of the received electronic communication to a first member of the group.

9. The method of claim 8 is further comprising:
displaying to the first member, on a display screen, the group intended electronic communication and a menu including a plurality of user selectable action items wherein each action item corresponds to a function to execute a predetermined set of instructions.

10. The method of claim 9 further comprising:
displaying on the display screen to the first member attribute and status information for enabling the first member to operate on the received electronic communication.

11. The method of claim 9 further comprising:
updating on the display screen to the first member the status information associated with the received electronic communication being operated on a ongoing basis by the members of the group including the first member.

12. The method of claim 9 in which the display screen comprises a window to present the group intended electronic communication and the menu.

13. A method for assisting members of an electronic mail group in an electronic mail system to access electronic mail within a group electronic mailbox, the method comprising:
receiving inbound electronic mail from a remote connection over a computer network, said inbound electronic mail comprising an item profile;
processing said item profile to derive distribution information for one or more recipients of the received inbound electronic mail, said distribution information comprising recipient address information;
determining from the recipient address information one or more intended recipients of the received electronic mail;
delivering the received electronic mail to the group electronic mailbox wherein said group electronic mailbox being shared by the members of the electronic mail group;
deriving from the item profile of the received electronic mail a plurality of attributes to identify the sender address information and the attribute information;
assigning a status to the received electronic mail to indicate the status of the received electronic mail to a first member of the group;
displaying to the first member, on a display screen, the received electronic mail and a menu including a plurality of user selectable action items, each action item representing a function; p1 displaying in the display screen to the first member the attribute and status information for allowing the first member to operate on the received electronic mail; and
updating on the display screen to the first member the status information associated with the received electronic mail being operated on by the members of the electronic mail group including the first member of the group.

14. The method of claim 13 in which the display screen comprises a window to display the received electronic mail and the menu.

15. An apparatus for distributing and sharing of electronic communication information to allow multiple users to work collaboratively and simultaneously with the electronic communication information, the apparatus comprising:
a central processing unit;
a computer memory, the computer memory storing instructions for:
providing to a first user a template to create a group comprising a plurality of members by selecting identifying information for each of said members;
completing the template with identifying information for each of said members to specify the group, the group assigned to a group identification number for associating the group identification number with a group electronic communication mailbox;
receiving inbound electronic communication information from a remote connection over a computer network, said inbound electronic communication information comprising a distribution;
processing said distribution to derive distribution information for one or more recipients of the inbound electronic communication information, said distribution information comprising recipient identification information;
determining from the recipient identification information one or more intended recipients of the inbound electronic communication information; and
directing the inbound electronic communication information to the group electronic communication mailbox wherein said group electronic mailbox being shared by the members of the group.

16. The apparatus of claim 15 in which the completed template is submitted for storage in a database.

17. The apparatus of claim 15 in which the group electronic mailbox comprises an inbox to receive one or more electronic communications delivered to the group electronic mailbox.

18. The apparatus of claim 15 in which each of the received electronic communications comprise an item profile with a plurality of attributes for the sender identifying and attribute information.

19. The apparatus of claim 15 in which a status indicator indicates a status assigned to each of the received electronic communications for presenting the received electronic communications to a first member of the group.

20. The apparatus of claim 19 further comprises for displaying to the first member, in a window on a display screen, a menu including a plurality of user selectable action items wherein each action item represents a function.

21. The apparatus of claim 20 for displaying in the window to the first member the attribute and status information allows the first member to operate on the received electronic communication.

22. The apparatus of claim 20 updates in the window to the first member the status information associated with the received electronic communication being operated on a ongoing basis by the members of the group including the first member.

23. In a computer readable medium, software for distributing and sharing of electronic communication information to allow multiple users to work collaboratively and simultaneously with the electronic communication information, the medium comprising:
software for providing to a first user a template to create a group comprising a plurality of members by selecting identifying information for each of said members;
software for completing the template with identifying information for each of said members to specify the group, the group assigned to a group identification number for associating the group identification number with a group electronic communication mailbox;
software for receiving inbound electronic communication information from a remote connection over a computer network, said inbound electronic communication information comprising a distribution;
software for processing said distribution to derive distribution information for one or more recipients of the inbound electronic communication information, said distribution information comprising recipient identification information;
software for determining from the recipient identification information one or more intended recipients of the inbound electronic communication information; and
software for directing the inbound electronic communication information to the group electronic communication mailbox wherein said group electronic mailbox being shared by the members of the group.
